(19) United States
(12) Patent Application Publication
(10) Pub. No.: US 2009/0040770 A1
(43) Pub. Date: Feb. 12, 2009

(54) Light Source Reflector

(76) Inventor: Kang Hua Lo, Taoyuan (TW)

Correspondence Address: LIN & ASSOCIATES INTELLECTUAL PROPERTY, INC., P.O. BOX 2339, SARATOGA, CA, 95070-0339, US

(21) Appl. No.: 11/834,687

(22) Filed: Aug. 7, 2007

(51) Int. Cl. F21V 13/04; F21V 7/04

(52) U.S. Cl. 362/327; 362/347

(57) ABSTRACT

A light source reflector includes a conical reflective surface, and a flat reflective surface formed on a rim of the conical reflective surface. The conical reflective surface has a plurality of unit curved surfaces with convex surfaces or concave surfaces. Also, the flat reflective surface is provided with a plurality of refraction protrusions, to improve the optical efficiency and light-mixing effect of the light source reflector.

### BACKGROUND OF THE INVENTION

1. Field of the Invention

The present invention relates to a reflector mounted with a light source, such as a light-emitting diode or a bulb, for reflecting the light beam emitted from the light source.

2. The Prior Arts

Generally, lamp devices for illumination purpose are assembled with a light source reflector to increase the light brightness.

With reference to FIG. 4, a conventional light source reflector A, which is integrally formed by injection molding, includes a conical reflective surface A2, and a flat reflective surface A1 formed on a rim of the conical reflective surface A2. An insertion hole is provided at a center of the conical reflective surface A2, through which a light source, such as a light-emitting diode or a bulb, can be inserted. When the light source disposed at the center of the conical reflective surface A2 is turned on, part of the light beam emits off the light source reflector A directly, and part of the light beam emits to the conical reflective surface A2 and is reflected off the light source reflector A by the conical reflective surface A2. Besides, the flat reflective surface A1 can reflect part of the light beam as well. However, because the flat reflective surface A1 does not reflect the light beam directly from the light source, the light reflection effect of the flat reflective surface A1 is relatively poor.

Although the above-mentioned conical reflective surface A2 of the conventional light source reflector has a curved mirror surface for providing an excellent reflection function, the light refraction and the light-mixing effect are still hard to be improved.

### SUMMARY OF THE INVENTION

The primary objective of the present invention is to improve the disadvantage of the conventional light source reflector that has the poor light-refracting and light-mixing effect.

Instead of the smooth reflective inner surface of the conventional light source reflector, the present invention provides a plurality of small unit curved surfaces on a conical reflective surface. Each of the unit curved surfaces has a smooth surface as well. As the light beam is emitted to the unit curved surfaces, the light beam can be not only excellently reflected, but also effectively refracted and mixed.

To achieve above-mentioned objective, a light source reflector in accordance with the present invention is integrally formed by injection molding and includes a conical reflective surface and a flat reflective surface formed on a rim of the conical reflective surface, in which a plurality of unit curved surfaces with a convex surface or a concave surface are formed on the conical reflective surface. A plurality of refraction protrusions are arranged on the flat reflective surface. The conical reflective surface and the flat reflective surface are processed to form a smooth mirror by using electroplating method, to improve the optical efficiency and light-mixing effect of the light source reflector.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a perspective view of a light source reflector in accordance with the present invention;

FIG. 2 is a top view of the light source reflector in accordance with the present invention;

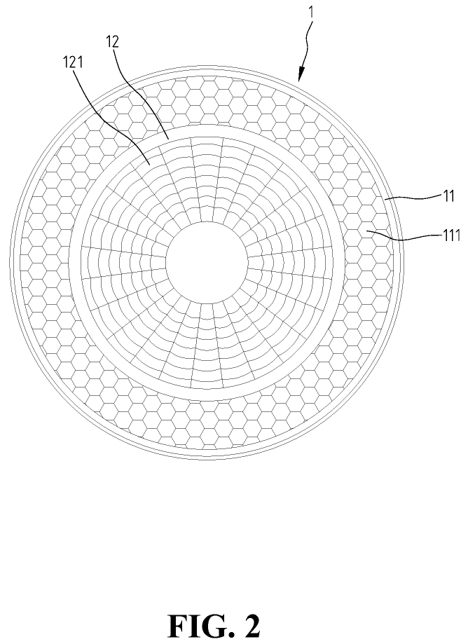

FIG. 3 is a cross-sectional view taken along a line across a center of the light source reflector in FIG. 2; and

FIG. 4 is a cross-sectional view showing a conventional light source reflector.

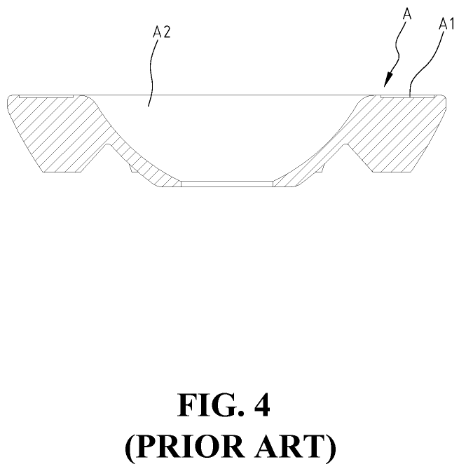

### DETAILED DESCRIPTION OF THE PREFERRED EMBODIMENT

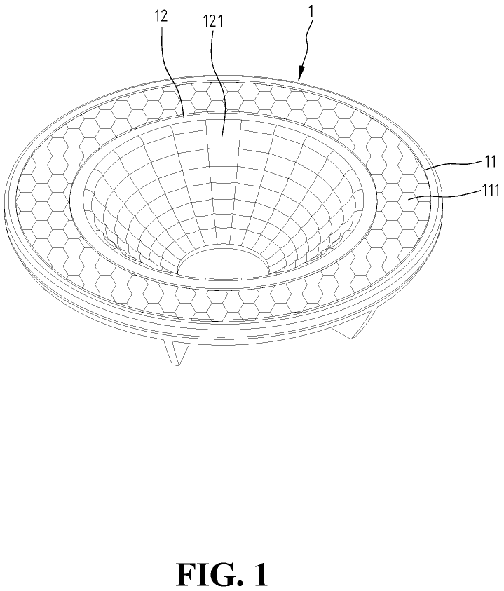

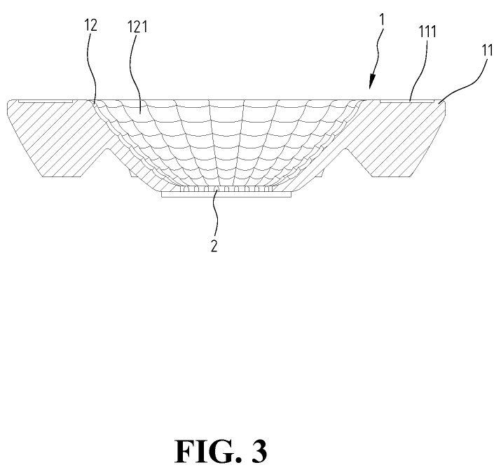

With reference to FIG. 1 and FIG. 3, a light source reflector 1 in accordance with a preferred embodiment of the present invention is integrally formed by injection molding, and includes a conical reflective surface 12 and a flat reflective surface 11 formed on a rim of the conical reflective surface 12. A plurality of unit curved surfaces 121 with proper sizes are formed on the conical reflective surface 12, in which the unit curved surfaces 121 may have a convex surface protruded from the conical reflective surface or a concave surface recessed in the conical reflective surface, such that the conical reflective surface is configured like a web. Furthermore, a plurality of refraction protrusions 111 are arranged on the flat reflective surface 11. The refraction protrusions 111 have proper size and may be of a pyramid or cone shape. The flat reflective surface 11 and the conical reflective surface 12 can be processed to form a smooth mirror by using electroplating method.

FIG. 3 shows the light source reflector 1 mounted to a light source 2 in accordance with an embodiment of the present invention. The light source 2 can be a light-emitting diode module or a bulb, which is inserted into a pre-opened aperture of the light source reflector 1. As the light source 2 is turned on, part of the light beam can be emitted off the light source reflector 1 directly, and part of the light beam can be emitted to the conical reflective surface 12 and then be reflected and refracted off the light source reflector 1 by the unit curved surfaces 121, so that the whole light-reflecting, light-refracting and light-mixing effect of the light source reflector 1 can be improved. Moreover, since the light source reflector 1 is generally assembled inside a glass shade, part of the light beam emitted to the glass shade can be reflected to the flat reflective surface 11 and then be reflected and refracted by the refraction protrusions 111 of the flat reflective surface 11. Accordingly, the whole optical effect of the light source reflector 1 can be improved.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. A light source reflector, comprising:
a conical reflective surface having an aperture at a center thereof for inserting a light source; and
a flat reflective surface formed on a rim of the conical reflective surface,
wherein a plurality of unit curved surfaces are formed on the conical reflective surface.

2. The light source reflector as claimed in claim 1, wherein the unit curved surface has a convex surface protruded from the conical reflective surface.

3. The light source reflector as claimed in claim 1, wherein the unit curved surface has a concave surface recessed in the conical reflective surface.

4. The light source reflector as claimed in claim 1, wherein the flat reflective surface has a plurality of refraction protrusions.

5. The light source reflector as claimed in claim 2, wherein the flat reflective surface has a plurality of refraction protrusions

6. The light source reflector as claimed in claim 3, wherein the flat reflective surface has a plurality of refraction protrusions
